(19) United States
(12) Patent Application Publication
(10) Pub. No.: US 2005/0140486 A1
(43) Pub. Date: Jun. 30, 2005

(54) Multi-layer chip inductive element

(76) Inventor: Hung-Wen Lin, Taichung County (TW)

Correspondence Address: BACON & THOMAS, PLLC, 625 SLATERS LANE, FOURTH FLOOR, ALEXANDRIA, VA, 22314, US

(21) Appl. No.: 10/760,342

(22) Filed: Jan. 21, 2004

(30) Foreign Application Priority Data
Dec. 26, 2003 (TW) 92222817

(51) Int. Cl. H01F 5/00

(52) U.S. Cl. 336/200

(57) ABSTRACT

A multi-layer chip inductive element includes at least two inductors connected with each other and mounted in an insulating ceramic material. Each of the inductors has a longitudinal axle parallel to the other and includes a plurality of conductor patterns and ceramic layers stacked upon one another in sectors, wherein inductive coils of each two adjacent inductors of the inductors are wound conversely to form sectors thereof. Accordingly, the coils can be increased without lengthening and heightening the element to further facilitate the production and enhance the yield.

### BACKGROUND OF THE INVENTION

1. Field of the Invention

The present invention relates generally to electronic components, and more particularly to a multi-layer chip inductive element.

2. Description of the Related Art

A conventional chip bead element is a structurally miniature inductive admixture of conductor patterns and powder of ferrite oxide that are stacked upon one another.

However, the aforementioned conventional chip bead element is defective and needs to be improved. It is well known in the prior art that higher inductance needs more inductive coils. When the coils that have to be made by through-hole process are densely increased inside the chip bead element, the production of the chip bead element becomes slower and more difficult to further incur more defective fraction. If the chip bead element is arranged upright, the height will be increased to incur difficulty for the production while the coils are increased.

### SUMMARY OF THE INVENTION

The primary objective of the present invention is to provide a multi-layer chip inductive element that inductive coils are formed in sectors so as not to lengthen or heighten the whole structure of the element while the inductive coils are increased.

The secondary objective of the present invention is to provide a multi-layer chip inductive element that facilitates the production to enhance the yield.

The foregoing objectives of the present invention are attained by the multi-layer chip inductive element that includes at least two inductors connected with each other and mounted in an insulating ceramic material. Each of the inductors has a longitudinal axle parallel to the other and includes a plurality of conductor patterns and ceramic layers stacked upon one another in sectors, wherein inductive coils of each two adjacent inductors of the inductors are wound conversely to form sectors thereof. Accordingly, the coils can be increased without lengthening and heightening the element to further facilitate the production and enhance the yield.

### BRIEF DESCRIPTION OF THE DRAWINGS

FIG. 1 is a perspective view of a preferred embodiment of the present invention;

FIG. 2 is a schematic view of the preferred embodiment of the present invention, illustrating a manufacturing step;

FIG. 3 illustrates the manufacturing step implemented after the step illustrated in FIG. 2;

FIG. 4 illustrates the manufacturing step implemented after the step illustrated in FIG. 3;

FIG. 5 illustrates the manufacturing step implemented after the step illustrated in FIG. 4;

FIG. 6 illustrates the manufacturing step implemented after the step illustrated in FIG. 5;

FIG. 7 illustrates the manufacturing step implemented after the step illustrated in FIG. 6;

FIG. 8 illustrates the manufacturing step implemented after the step illustrated in FIG. 7;

FIG. 9 is another perspective view of the preferred embodiment of the present invention having three inductors; and

FIG. 10 is another perspective view of the preferred embodiment of the present invention having four inductors.

### DETAILED DESCRIPTION OF THE INVENTION

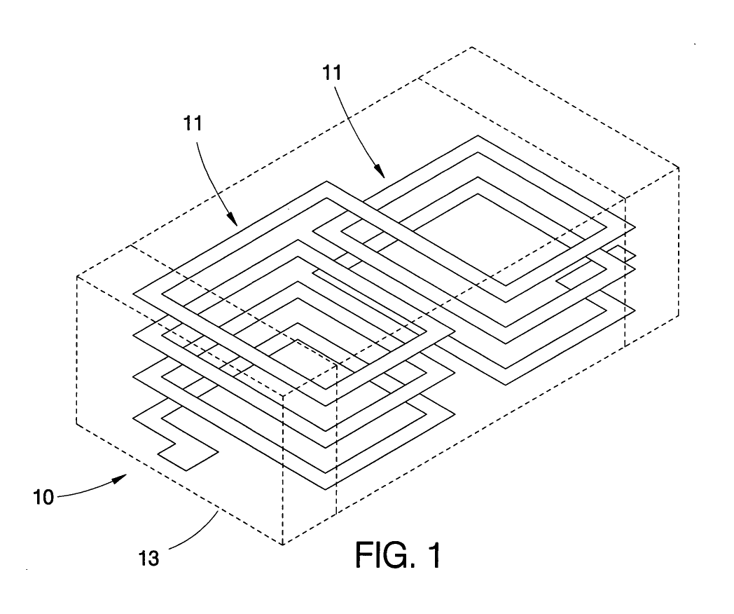

Referring to FIG. 1, a multi-layer chip inductive element 10 includes at least two inductors 11 which are embodied as two adjacent inductors 11.

The two inductors 11 are connected with each other and are mounted in an insulating ceramic material 13. Each of the two inductors 11 has a longitudinal axle parallel to the other and has a plurality of inductor patterns and ceramic layers stacked upon one another in sectors. Inductive coils of the two inductors are conversely coiled to be formed in sectors. When the inductor patterns are stacked upon one another, the inductor patterns are partially contacted one another.

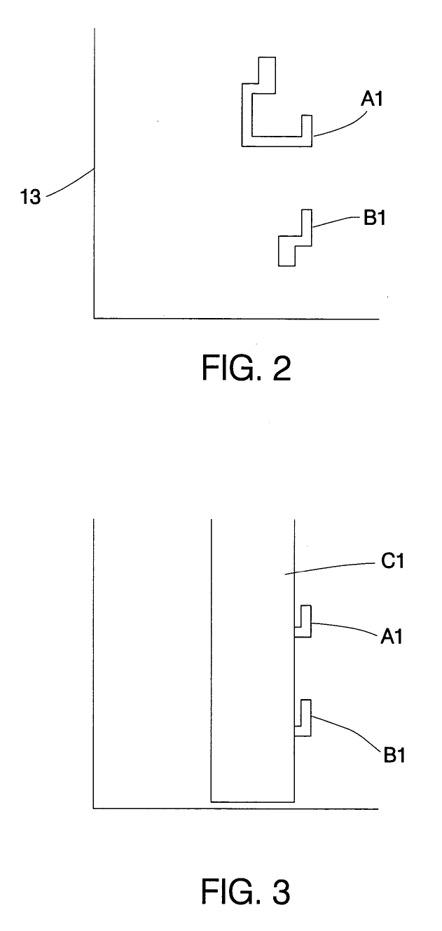

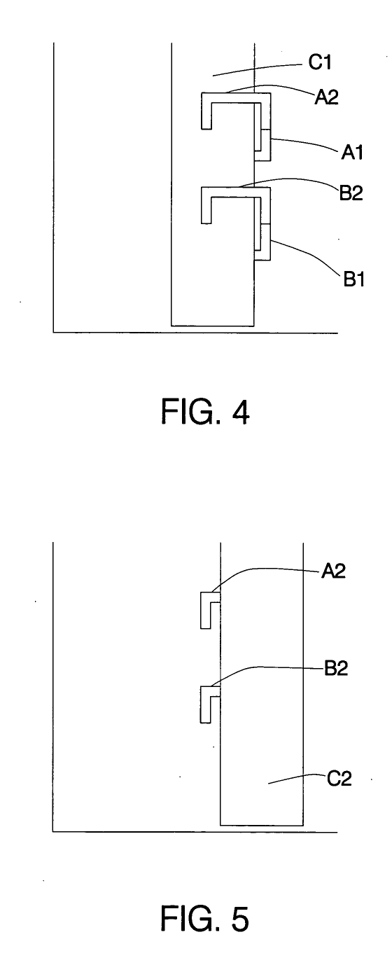

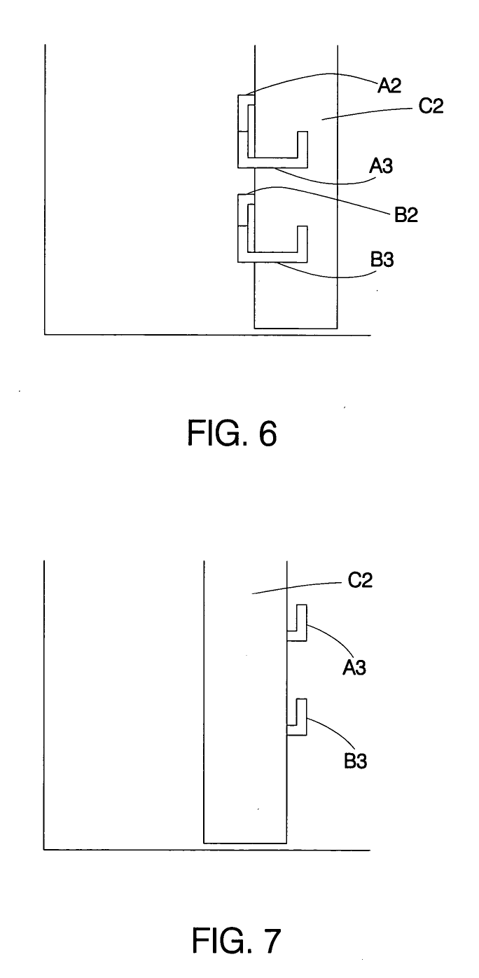

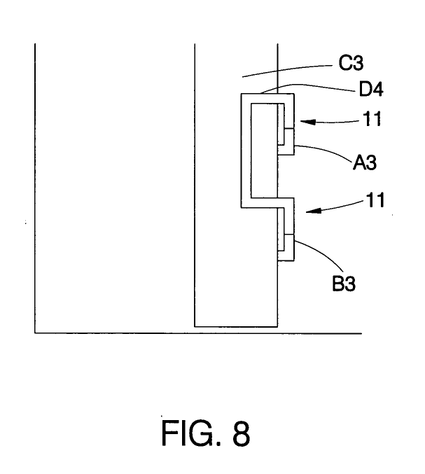

FIGS. 1-8 illustrate manufacturing process of the present invention steps by steps. As shown in FIGS. 2, when the present invention is manufactured, two first conductor patterns A1 and B1 are disposed on an insulating ceramic material 13. Because the inductive coils of the two conductors 11 are conversely coiled, the two first conductor patterns A1 and B1 are different in shape. As shown in FIG. 3, a ceramic layer C1 is disposed on the two first conductor patterns A1 and B1 and parts of the two first conductor patterns A1 and B1 are exposed outside. As shown in FIG. 4, two second conductor patterns A2 and B2 are stacked upon the ceramic layer C1 and respectively contact the two first conductor patterns A1 and B1. As shown in FIG. 5, another ceramic layer C2 is disposed on the two second conductor patterns A2 and B2 and parts of the two second conductor patterns A2 and B2 are exposed outside. As shown in FIG. 6, two third conductor patterns A3 and B3 are stacked upon the ceramic layer C2 and respectively contact the two second conductor patterns A2 and B2. As shown in FIG. 7, one another ceramic layer C3 is disposed on the two third conductor patterns A3 and B3 and parts of the two third conductor patterns A3 and B3 are exposed outside. As shown in FIG. 8, a linking conductor pattern D4 is disposed on the ceramic layer C3 and interconnects the two third conductor patterns A3 and B3. Thus, the multi-layer chip inductive element 10, as shown in FIG. 1, is formed by that the two inductors 11 are interconnected and conversely coiled. In addition, repeat the steps illustrated in FIGS. 4-7 to increase the number of the coils of the inductors 11.

Referring to FIG. 1, the two inductors 11 are connected with each other and are conversely coiled. Although the two inductors 11 are structurally axially parallel to each other, the two inductors 11 are connected with each other to be tandem connected, such that the inductance of the multi-layer chip inductive element 10 is the total amount of the inductance of the two inductors 11. Accordingly, the inductance of the present invention can be increased by the two parallel arranged and tandem connected inductors within a predetermined height, and the inductors 11 are formed in sectors inside the insulating ceramic material 13, such that increasing coils of the inductors 11 will not heighten the element 10.

Please note that the aforementioned FIGS. 2-8 merely illustrate the manufacturing process of the inductors to be the insignificant technical feature of the present invention. The present invention focuses on the significant technical feature that the inductors are formed in sectors and axially parallel to each other without heightening the element.

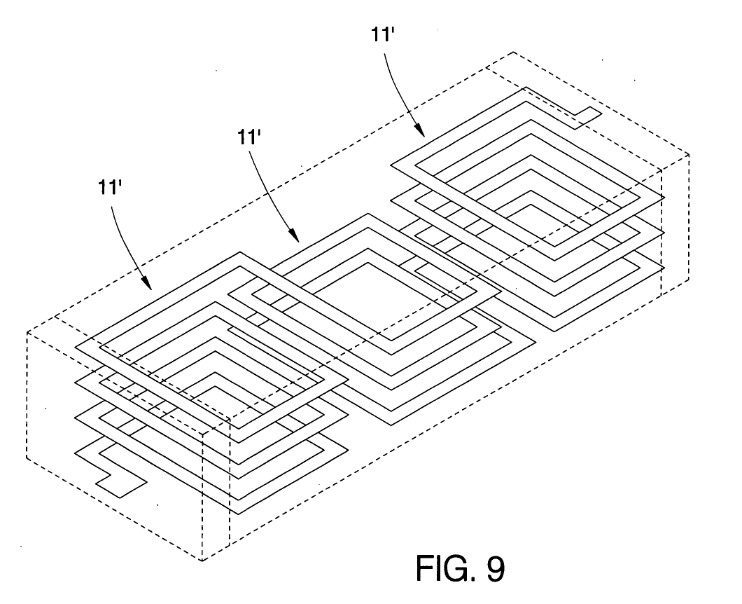

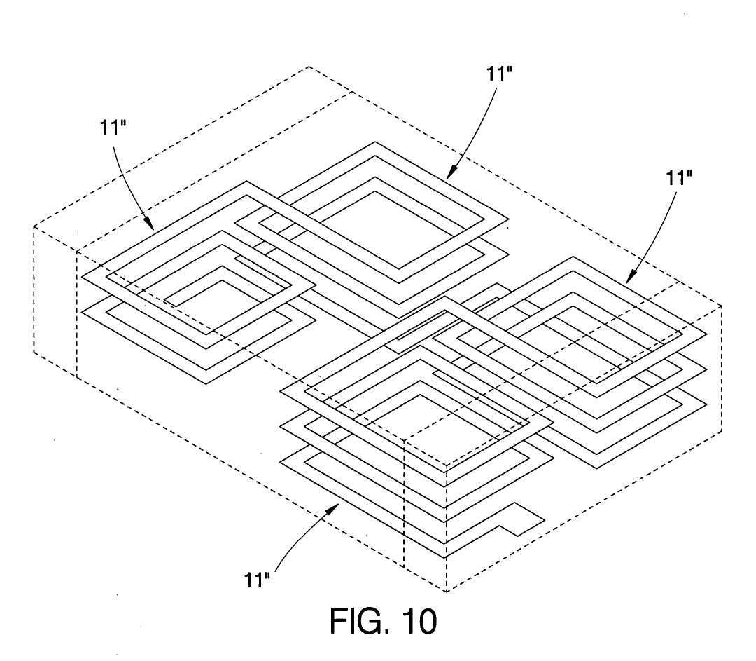

Referring to FIGS. 9-10, the present invention can alternatively include three inductors 11′ or four inductors 11″ to attain the primary and secondary objectives and to further generate higher inductance.

In conclusion, the present invention includes the following advantages.

1. The inductive coils of the present invention can be formed in sectors and can be increased in number without heightening the element to further improve the defective of the prior art.

2. The height and the length of each inductor of the present invention can be kept regular to avoid irregular height or length that makes it difficult for the production, such that the production yield of the present invention can be kept invariable to enable the production in advantageous condition.

1. A multi-layer chip inductive element comprising at least two inductors connected with each other and mounted inside an insulating ceramic material, each of said inductors having a longitudinal axle parallel to the other and having a plurality of conductor patterns and ceramic layers stacked upon one another in sectors, inductive coils of each two adjacent inductors of said inductors being conversely coiled.

2. The multi-layer chip inductive element as defined in claim 1, wherein said conductor patterns of said conductors partially contact each other while stacked upon one another.
